(19) United States
(12) Patent Application Publication
(10) Pub. No.: US 2016/0239867 A1
(43) Pub. Date: Aug. 18, 2016

(54) Online Shopping Cart Analysis

(71) Applicant: Adobe Systems Incorporated, San Jose, CA (US)

(72) Inventors: Moumita Sinha, Kolkata (IN); Kandarp S. Khandwala, Mumbai (IN); Harvineet Singh, Ludhiana (IN); D. P. Tejas, Arsikere (IN)

(21) Appl. No.: 14/623,248

(22) Filed: Feb. 16, 2015

(51) Int. Cl. G06Q 30/02; G06N 99/00; G06Q 30/06

(52) U.S. Cl. CPC G06Q 30/0255; G06Q 30/0633; G06Q 30/0269; G06Q 30/0257; G06N 99/005

(57) ABSTRACT

Online shopping cart analysis is described. In one or more implementations, a model is built is usable to compute a likelihood of a given customer that leaves an online store with unpurchased items in an online shopping cart will return to purchase those items. To build the model, historical data that describes online store interactions and attributes of unpurchased items in online shopping carts is collected for other customers that have abandoned online shopping carts. Using the model, data collected for a subsequent customer that has abandoned an online shopping cart is input and the likelihood of that customer to return to purchase unpurchased items is returned as output. Based on the computed likelihood, the customer may be associated with different advertising segments that correspond to different marketing strategies. Marketing activities directed to the subsequent customer are thus controllable using the model.

### BACKGROUND

When shopping online (e.g., at e-commerce web sites such as Amazon®), customers often add items to an online shopping cart and then terminate their shopping session without purchasing those items. By terminating a shopping session without purchasing items held in an online shopping cart, a customer has “abandoned” the online shopping cart.

Advances in online shopping techniques have led to online shopping carts that persist over multiple shopping sessions. These online shopping carts are referred to as “persistent” online shopping carts. With a persistent online shopping cart, a customer may return to an online shopping cart that was abandoned at an earlier shopping session. Upon return, the customer is able to view and edit items that were left in the online shopping cart when an earlier shopping session was terminated.

Persistent online shopping carts have changed the manner in which customers interact with online stores. By way of example, items are purchased by customers from online stores that are selected via multiple shopping sessions. Some customers, for instance, use an online shopping cart as a wish list, perform comparison shopping at multiple stores for items added to the online shopping cart, and so forth. To do so, a customer adds the same items to online shopping carts at each of the different online stores and compares a total price (or other comparison metric) of the items. A customer may then choose to purchase the items from one of the online stores based on the comparison.

In general, each online store vies to be the one from which a customer purchases items left in a persistent shopping cart. Consequently, targeted advertising content may be delivered on behalf of an online store to “convince” customers with abandoned online shopping carts to return to the online store and purchase items left in the abandoned carts. However, merely sending a reminder email that states, “You have unpurchased products in your cart”, can lead to brand irritation and potentially lost customers. Accordingly, conventional techniques for analyzing online shopping carts do not produce information that is suitable for effectively targeting advertising content to customers that have abandoned online shopping carts.

### SUMMARY

Online shopping cart analysis is described. In one or more implementations, a model is built that is usable to compute a likelihood that a given customer that leaves an online store with unpurchased items in an online shopping cart will return to purchase the unpurchased items. To build the model, other customers that have left the online store with unpurchased items in online shopping carts are identified. Once identified, historical data for these customers is collected that describes their interactions with the online store as well as attributes of items in their online shopping carts. For example, browsing data that describes a manner in which these customers browse through an online store is collected, including products that the customers viewed, how the customers navigated to those products, and so on. Further, the data describing attributes of the items in the online shopping carts may include an average amount of time the items are held in an online shopping cart, an average price of the items in an online shopping cart, a total cost of items in an online shopping cart, and so on.

Once the model is built, a likelihood is computed of a subsequent customer that leaves an online store with unpurchased items in an online shopping cart to return to purchase those items. To compute the likelihood for the subsequent customer, data indicative of the subsequent customer's interactions with the online store and attributes of the unpurchased items left in the subsequent customer's online shopping cart are collected. Using the model, the data collected for the subsequent customer is input, and the likelihood of the customer to return to purchase the unpurchased items is returned as an output. Based on the computed likelihood, the customer may be associated with an advertising segment. Different advertising segments may correspond to different marketing activities, such that no targeted advertising action is taken for customers in one advertising segment while advertising actions (e.g., sending emails offering free shipping) are taken for customers in another advertising segment. Thus, marketing activities directed to subsequent customers are controllable using the model.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a digital marketing environment in an example implementation that is operable to employ techniques described herein.

FIG. 2 illustrates from the environment from FIG. 1 a service provider and a computing device having an online shopping cart analysis module in greater detail.

FIG. 3 is a flow diagram depicting a procedure in an example implementation in which data is collected for customers that have left an online store with unpurchased items in an online shopping cart, and in which marketing activities directed at subsequent customers are controlled using a model that is built from the collected data.

FIG. 4 is a flow diagram depicting a procedure in an example implementation in which a customer that leaves an online store with unpurchased items in an online shopping cart is associated with a marketing segment based on a likelihood of the customer to return and purchase the unpurchased items.

FIG. 5 illustrates an example system including various components of an example device that can be employed for one or more implementations of online shopping cart analysis techniques described herein.

### DETAILED DESCRIPTION

### Overview

Businesses may be limited in the ways they target content (e.g., banner advertisements, promotional emails, search results, recommendations, and so on) to consumers, in part, because conventional techniques fail to identify consumers that are likely to be convinced to purchase items left in their abandoned online shopping carts. It is estimated that a significant number of consumers have abandoned shopping carts that persist online. Items left in these abandoned shopping carts therefore represent large revenues for businesses with online stores, if the items are purchased. Thus, businesses strive to increase a rate at which consumers return to their online stores to purchase items left in abandoned online shopping carts. Convincing consumers to return to purchase items left in an online shopping cart may be challenging, however, as doing so may depend at least in part on addressing the reasons the online shopping carts were abandoned.

Online shopping carts may be abandoned for a variety of reasons. For example, an online shopping cart may be abandoned because a customer believes that the shipping costs are too high, a cost of items in the online shopping cart is shown late in the checkout process, a customer was not ready to buy the items in the cart but merely wanted to save them for later consideration, a customer wanted to compare prices of the items in a cart to the price at other online stores because the customer was not ready to pay the price quoted at the online store, and so on.

Having some insight about “why” an online shopping cart is abandoned enables advertisers to deliver more effective advertising content, e.g., content that results in a greater number of customers returning to purchase items left in abandoned shopping carts. If, for example, it is determined that an online shopping cart has been abandoned because the shipping costs are believed to be too high, advertising content that enables the customer to get free shipping may be delivered to the customer. However, it may be beneficial for an advertiser to identify that a customer is likely or not likely to return to purchase the items in an abandoned shopping cart. This way the advertiser may avoid annoying such customers with unwanted advertising content.

Conventional techniques predict the propensity of a customer to purchase an item during a particular shopping session. For example, when a customer adds an item to a cart during a shopping session and selects a “check out” button, conventional techniques may be able to predict that the customer has a 35% likelihood of making a purchase. However, conventional techniques do not predict the propensity of a customer that abandoned items in a persistent shopping cart, at an earlier shopping session, to return to the online store to make a purchase. Further, conventional techniques do not use models that account for a number of cart interactions by a customer during a shopping session, a size of an online shopping cart, and a price of the items in an online shopping cart. Broadly speaking, conventional techniques do not predict a probability that a customer will return to make a purchase using data that relates to persistent online shopping carts, e.g., online shopping carts that have been abandoned over multiple shopping sessions.

Online shopping cart analysis is described. In one or more implementations, historic data about customers that abandon online shopping carts is used to provide targeted advertising content to subsequent customers that terminate shopping sessions at an online store without purchasing items left in their online shopping carts. Unlike conventional techniques which predict a likelihood of a given customer to make a purchase during a particular shopping session, a likelihood of a given customer to return to an online store to purchase items the customer abandoned in an online shopping cart may be computed. To do so, a model (e.g., a regression model) may be built that enables the likelihood-to-return computation. The likelihood may be computed based on interactions of the given customer at the online store, attributes of the items left in the abandoned shopping cart, and interactions of the given customer with cross-channel information, e.g., interactions with emails that are sent to the customer regarding the online store.

In further contrast with conventional techniques, the likelihood may be computed using data associated online shopping carts (e.g., describing customer interactions and attributes of items left in online shopping carts) that are abandoned at multiple shopping sessions. Once computed, the customer is associated with an advertising segment according to the customer's likelihood to return to purchase the items left in the abandoned shopping cart. Advertising content that is customized for the advertising segment is then delivered to the customer.

To build the model, historic data about customers that have left an online store without purchasing items left in their online shopping carts is collected. The collected data includes data describing interactions of online shopping cart abandoners with the online store (e.g., clickstream data), such as interactions of the abandoners to click on different parts of a web site of the online store (e.g., items for purchase, menu items, advertisements, and so on), navigate to different pages, add items to an online shopping cart, remove items from an online shopping cart, and so on.

The historic data collected for the abandoners may also include data that describes items left in the abandoned carts, such as an average price of items in the shopping cart, an average amount of time the items have been left in the shopping cart, and so on. Since data may be tracked for customers over multiple shopping sessions, historical data about an abandoner's purchases may also be collected. For example, historical data describing attributes of items that the abandoners have purchased from the cart may be collected. The attributes collected about purchased items include an amount of time purchased items are left in the cart before being purchased, an average price of the purchased items, and so on.

Accordingly, the model is configured to indicate that a subsequent customer that abandons an online shopping cart, has performed certain interactions with the online store, whose abandoned items have certain attributes, and that has performed certain interactions with cross-channel information of the online store (e.g., promotional emails), has a certain likelihood of returning to the online store to purchase the items left in the abandoned shopping cart. To enable computation of the likelihood, data that describes the subsequent abandoner's interactions with the online store, attributes of the items left in the abandoned shopping cart, and interactions with the cross-channel information is collected. The data collected for the subsequent customer then serves as input to the model and the likelihood is returned as output.

The computed likelihood is then be used as a basis for delivering targeted advertising content to the subsequent customer. By way of example, no advertising actions are taken for a customer that is determined likely to return to purchase the items left in an abandoned shopping cart. This may be the case when an advertiser determines that customers who will return to purchase unpurchased items are more likely to be annoyed by targeted advertising than convinced to return to the online store.

In contrast, the computed likelihood may indicate that there is some uncertainty as to whether a customer will to return to purchase items left in an abandoned cart. Advertisers may send these customers advertising content in an effort to convince them to return. The advertising sent to these customers is tailored to each based on the data collected. For example, if the collected data indicates that a customer seems to be comparison shopping with other online stores, an advertiser communicates advertising content that enables the customer to purchase the items left in the abandoned shopping cart for less than at the other online stores.

By delivering advertising content to customers that are classified in this way, advertisers are able to concentrate their resources (e.g., advertising budgets) on the customers that are determined to be most receptive to advertising. Furthermore, the customers to which the targeted advertising content is delivered may be expanded or decreased based on an advertising budget. With a greater advertising budget, for instance, customers that are 30-60% likely to return may be delivered advertising content versus just customers that are 50-60% likely to return. By using the techniques described herein, businesses are able to convince a greater number of customers to return to purchase items in abandoned online shopping carts than businesses using conventional techniques.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

### Example Environment

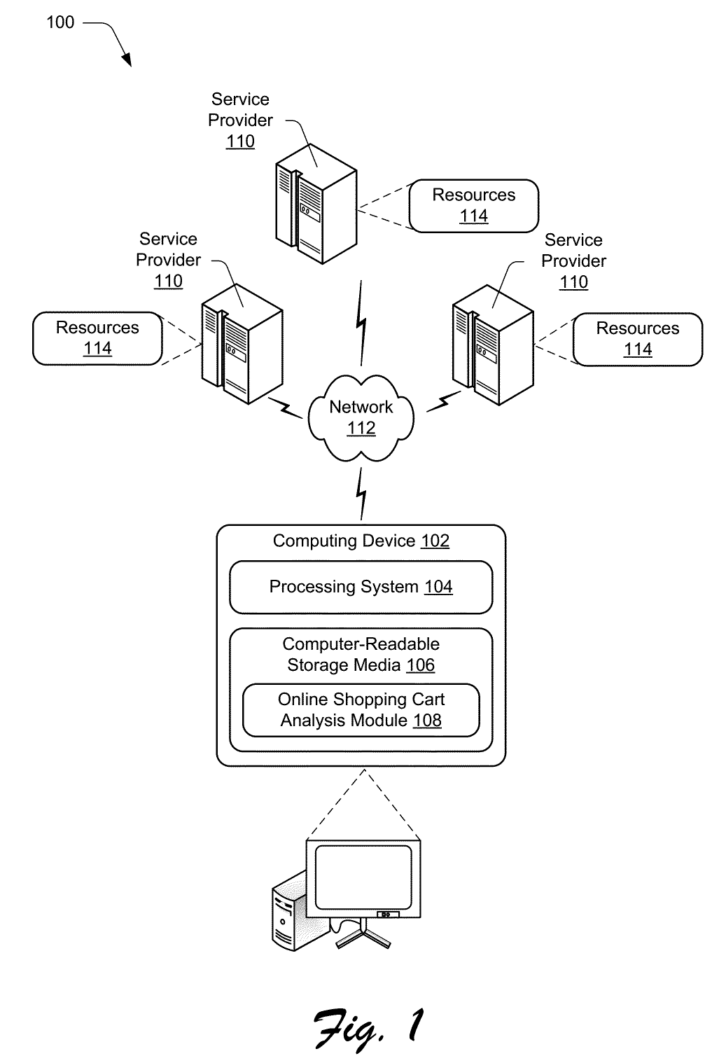

FIG. 1 is an illustration of an environment 100 in an example implementation that is operable to employ techniques described herein. The illustrated environment 100 includes a computing device 102 having a processing system 104 that includes one or more processing devices (e.g., processors), one or more computer-readable storage media 106, and an online shopping cart analysis module 108 embodied on the computer-readable storage media 106 and operable via the processing system 104 to implement corresponding functionality described herein. In at least some implementations, the computing device 102 includes functionality to access various kinds of web-based resources (content and services), interact with online providers, and so forth as described in further detail below.

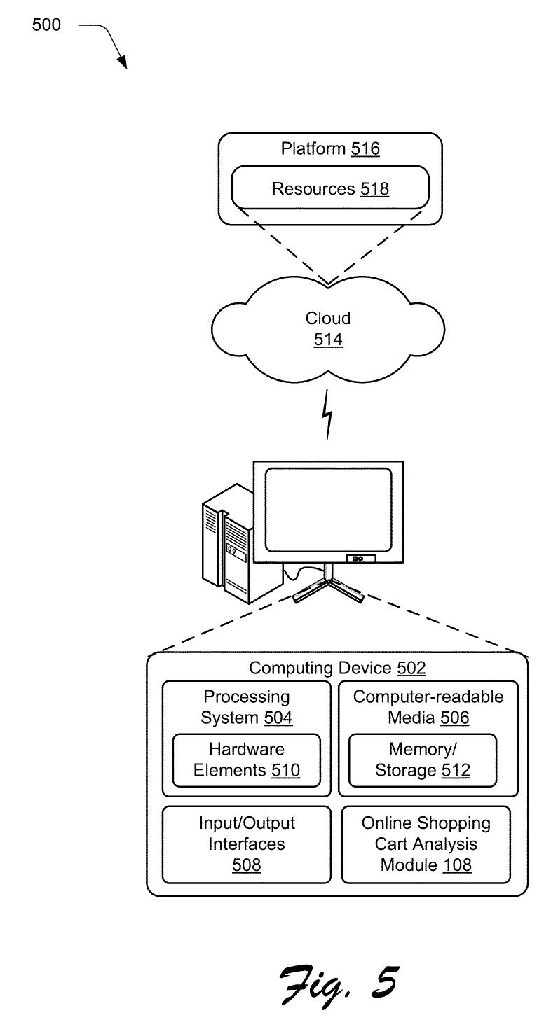

The computing device 102 is configurable as any suitable type of computing device. For example, the computing device 102 may be configured as a server, a desktop computer, a laptop computer, a mobile device (e.g., assuming a handheld configuration such as a tablet or mobile phone), a tablet, a device configured to receive gesture input, a device configured to receive three-dimensional (3D) gestures as input, a device configured to receive speech input, a device configured to receive stylus-based input, a device configured to receive a combination of those inputs, and so forth. Thus, the computing device 102 may range from full resource devices with substantial memory and processor resources (e.g., servers, personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 5.

The environment 100 further depicts one or more service providers 110, configured to communicate with computing device 102 over a network 112, such as the Internet, to provide a “cloud-based” computing environment. Generally speaking, service providers 110 are configured to make various resources 114 available over the network 112 to clients. In some scenarios, users sign up for accounts that are employed to access corresponding resources from a provider. The provider authenticates credentials of a user (e.g., username and password) before granting access to an account and corresponding resources 114. Other resources 114 are made freely available, (e.g., without authentication or account-based access). The resources 114 can include any suitable combination of services and/or content typically made available over a network by one or more providers. By way of example and not limitation, such services include, but are not limited to, online stores (e.g., Amazon®, Best Buy®, Walmart®, Costco®, and so on) via which a customer selects items such as goods or services for potential purchase and for which an online shopping cart is used to maintain the user-selected goods.

These online stores serve as significant sources of revenue for a variety of businesses and are a means by which many consumers acquire goods and services. Such online stores range from small online stores, having websites that sell just one or a few goods or services through third-party cart and merchant-service technologies, to large online retailers, such as Amazon® where products from an ever-growing number of other online retailers are purchased. The online shopping carts of at least some of these online stores are capable of persisting over multiple shopping sessions for customers that have accounts with those services, or through the use of other technologies, such as cookies. A “cookie” refers to a piece of data that is sent from a website and is stored in a web browser while a user browses the website. When the user subsequently loads the website, the browser sends the cookie back to the corresponding server to notify the web site of the user's previous activity, e.g., to notify the website of the items that were in an online shopping cart during a previous shopping session.

The online shopping cart analysis module 108 represents functionality to implement online shopping cart analysis techniques as described herein. For example, the online shopping cart analysis module 108 is configured in various ways to compute a likelihood of a customer that leaves an online store with unpurchased items in an online shopping cart to return to purchase those items. Based on the computed likelihood, the online shopping cart analysis module 108 associates the customer with an advertising segment. To this extent, the online shopping cart analysis module 108 also then communicates advertising content associated with the advertising segment to the customer. By customizing marketing content for customers based on their likelihood of returning to purchase items in an abandoned cart, businesses may be able to convince a greater number of customers to actually return and purchase those items.

With regard to computing the likelihood of a given customer to return to an online store and purchase items from an abandoned shopping cart, the online shopping cart analysis module 108 uses a model. The model, if given data describing the given customer's interactions with the online store, attributes of items in the customer's abandoned cart, and the given customer's interactions with cross-channel information, enables the online shopping cart analysis module 108 to compute the likelihood of the customer to return to purchase the items. To build a model configured in this way, the online shopping cart analysis module 108 uses historic data collected from other customers that have abandoned online shopping carts.

Thus, the online shopping cart analysis module 108, in conjunction with building the model, identifies customers of the online store that have abandoned online shopping carts. Historic data about the identified customers (e.g., data tracked by the online shopping cart analysis module 108 over one or more shopping sessions) is collected. The online shopping cart analysis module 108, for instance, tracks and collects data describing interactions of the identified customers with the online store (e.g., store browsing data), attributes of items left in shopping carts abandoned by the identified customers (e.g., shopping cart data), interactions of the identified customers with content associated with the online store but interacted with via different channels such as email (e.g., cross-channel data), and so forth. When a likelihood of a given customer to return to purchase items in an abandoned cart is to be computed, the online shopping cart analysis module 108 collects similar data about the given customer.

In one or more implementations, the online shopping cart analysis module 108 is implementable as a software module, a hardware device, or using a combination of software, hardware, firmware, fixed logic circuitry, etc. Further, the online shopping cart analysis module 108 is implementable as a standalone component of the computing device 102 as illustrated. In addition or alternatively, the online shopping cart analysis module 108 is configured as a component of a web service, an application, an operating system of the computing device 102, a plug-in module, or other device application as further described in relation to FIG. 5.

Having considered an example environment, consider now a discussion of some example details of the techniques for online shopping cart analysis in accordance with one or more implementations.

### Online Shopping Cart Analysis Details

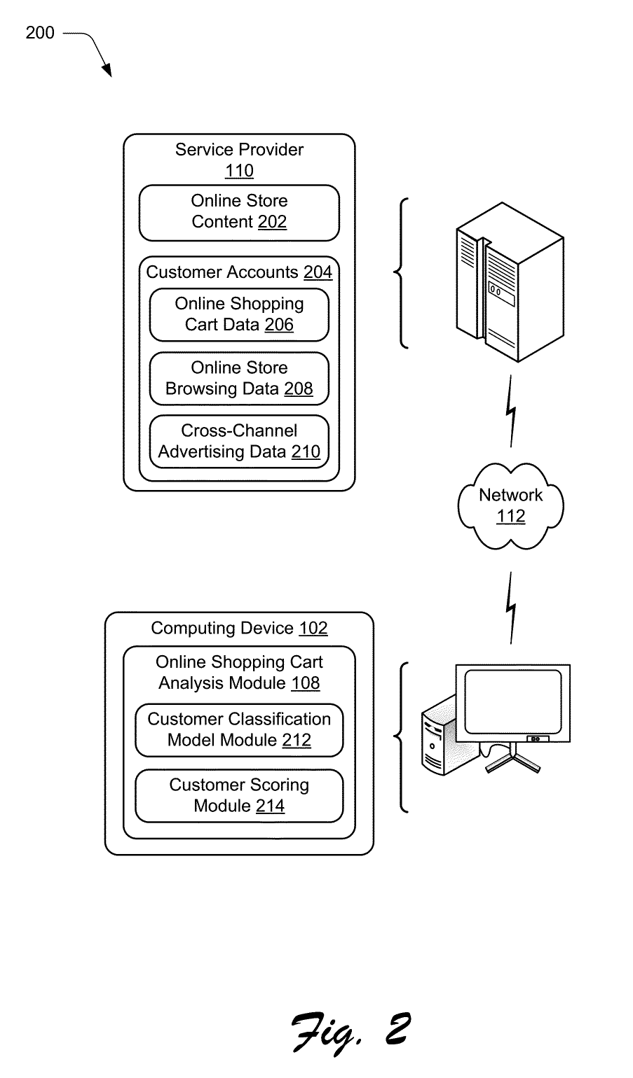

This section describes some example details of online shopping cart analysis techniques in accordance with one or more implementations. FIG. 2 depicts generally at 200 some portions of the environment 100 of FIG. 1, but in greater detail. In particular, the computer-readable storage media 106, the service provider 110, and the components included therein are depicted in greater detail.

In general, the service provider 110 depicted in FIG. 2 serves as a source through which items such as goods and services are purchased. By way of example, the service provider 110 corresponds to an online store that is implemented in the form of a website having multiple web pages. The web pages of the online store are implemented using a variety of content, including hypertext markup language (HTML), text, images, videos, advertising content, script, and so forth. This content for configuring the web pages of the online store is represented by online store content 202.

Service provider 110 is also depicted with customer accounts 204. The customer accounts 204 represent data associated with customers that have signed up for accounts with the online store. A customer may be able to take advantage of a variety of conveniences and benefits by signing up for an account with an online store. For example, a customer that signs up for an account with an online store may enter data (e.g., credit card number, shipping address, billing address, and so on) once and then have the data saved for future purchases. By doing so, the customer is able to quickly checkout from the online store, e.g., by simply confirming a credit card number, shipping address, and billing address rather than re-entering that data each time the customer checks out. Additionally, a customer that signs up for an account enables the customer to receive advertising content for deals offered by the online store. For example, the customer may receive emails enabling the customer to take advantage of discounted pricing that is not available to customers without customer accounts.

Having a customer account also enables a customer to add items from the online store to a shopping cart during a shopping session, end that shopping session, come back for a later shopping session, and have the same items in the cart at the later shopping session. As noted above, online shopping carts having this sort of functionality are referred to as “persistent” online shopping carts. To the extent that online shopping carts persist over multiple shopping sessions, these shopping carts are also capable of being “abandoned” by a customer, e.g., when a customer navigates to a different website or closes a web browser but leaves items in the online shopping cart.

Returning to the discussion of conveniences and benefits associated with the customer accounts 204, having a customer account with the service provider 110 enables data for a customer to be tracked. In FIG. 2, the customer accounts are illustrated with online shopping cart data 206, online store browsing data 208, and cross-channel advertising data 210. Accordingly, the service provider 110 causes at least the online shopping cart data 206, the online store browsing data 208, and the cross-channel advertising data 210 for a customer to be tracked. For instance, this data is maintained (e.g., in databases) along with other data (e.g., credit card information, addresses, and so on) of the customer accounts 204. Such other data may also include a designation for a customer as a business-to-business (B2B) customer or a business-to-consumer (B2C) customer. In general, there is a much stronger correlation between B2B customers that add an item to an online shopping cart to purchase the added item than B2C customers.

In any case, the online shopping cart data 206 represents a variety of data associated with items added to, removed from, and purchased from an online shopping cart. For example, the online shopping cart data 206 describes attributes of items in persistent shopping carts that have been abandoned in an earlier shopping session, such as a median age of items that are purchased from an online shopping cart, a median age of unpurchased items in an online shopping cart, a number of cart interactions a customer has per shopping session, an average time between a first interaction of a customer with an online shopping cart and purchase of items from the online shopping cart, an average number of searches performed for products per session after the online shopping cart is abandoned, and so forth.

The online shopping cart data 206 also describes attributes such as a size of the online shopping cart (in terms of quantity of items and total price of the items in the online shopping cart), an average price of the items in the online shopping cart, and so forth. The online shopping cart data 206 may describe other attributes related to online shopping carts and the items therein, removed therefrom, or purchased therefrom, without departing from the spirit or scope of the techniques described herein.

The online store browsing data 208 represents a variety of data associated with how customers interact with the online store, including interactions with a corresponding shopping cart. For example, the online store browsing data 208 may correspond to clickstream data. The clickstream data indicates where in a website a user “clicks”, e.g., menu items, buttons, dropdowns, hyperlinks, scrolling selections, and so on. As used herein, the term clickstream data also indicates a location of a user's cursor relative to objects displayed on a webpage. In other words, the clickstream data indicates where a cursor hovers on a webpage.

In any case, the online store browsing data 208 corresponds to clickstream data that describes a number of different types of interactions with an online shopping cart (e.g., addition, subtraction, change of items in a cart, and so on), searches performed by the customer, purchasable items that the customer views, interactions associated with checking out and ordering (e.g., selection of a button to “view cart & checkout”, selection when viewing the items in an online shopping cart of a button to “proceed to checkout”, filling out billing and shipping addresses, filling out credit card information, selecting a button to “confirm purchase”, and so on).

In addition, online store browsing data 208 includes data that describes a customer's browsing activities after the customer has left the online store and browsing activities performed while shopping at the online store, e.g., in a different tab of a web browser. By way of example, the online store browsing data 208 describes other websites visited by the customer, searches performed by the customer via a search engine, and so on. The online store browsing data 208 may also represent other data indicative of a customer's shopping-related interactions without departing from the techniques described herein.

The cross-channel advertising data 210 represents a variety of data that describes interactions of customers with content outside of an online store's website. By way of example, the cross-channel advertising data 210 may describe interactions of a customer with an email associated with the online store (e.g., whether the customer viewed the email, simply deleted the email, selected portions of the email, and so on), interactions of the customer with a video advertisement delivered via a video game system, interaction of the customer with promotional games, interactions of the customer to click on banner advertisements displayed as part of websites other than the online store, and so on. When a customer opens and read an email from an online store, it can indicate that the customer is still interested in returning to the online store to make a purchase, even if the customer has not returned to browse the online store. Such actions may indicate that the customer is collecting more information about items before returning to the abandoned cart to make a purchase. It should be appreciated that the cross-channel advertising data 210 may describe still other cross-channel based interactions than those enumerated above without departing from the spirit and scope of the techniques described herein.

One challenge associated with advertising is to determine how much of an advertising budget to allocate to different advertising segments. By way of example and not limitation, customers that have abandoned online shopping carts are segmented into three advertising segments: (1) customers that will not return to purchase the items left in an abandoned cart (referred to herein as “true abandoners”), (2) customers that may, with greater incentives, return to the online store to purchase the items left in an abandoned cart (referred to herein as “prospects”), and (3) customers that will definitely return to the online store to purchase items left in an abandoned cart (referred to herein as “true customers”).

When customers are segmented in this way, it may make sense for an advertiser to allocate a sizable portion of its advertising budget to campaigns that target the customers classified as prospects. Given this, however, the prospects must be identified from the customers that abandon their online shopping carts. The techniques described herein enable customers that abandon online shopping carts to be segmented into true abandoners, prospects, and customers, thus enabling the prospects to be identified.

When a customer abandons an online shopping cart, the browsing activity of the customer is observed. Taking into account the customer's in-session behavior (e.g., the customer's browsing interactions with the online store over one or more shopping sessions), attributes of the online shopping cart and past interactions with the online shopping cart, and cross-channel interactions (e.g., interactions with promotional emails), a model is built to predict whether a customer will return to the online store to purchase the items in left in an abandoned cart.

In FIG. 2, the online shopping cart analysis module 108 is illustrated with a customer classification model module 212 and a customer scoring module 214. These modules represent functionality of the online shopping cart analysis module 108 and it should be appreciated that such functionality may be implemented using more or fewer modules than those illustrated.

In general, the customer classification model module 212 represents functionality to generate models that are usable for predicting whether a customer will return to the online store to purchase the items in left in an abandoned cart. To do so, the customer classification model module 212 generates the model from data collected about historic customers that are identified as having abandoned online shopping carts. In particular, the customer classification model module 212 generates the model from the online shopping cart data 206, online store browsing data 208, and the cross-channel advertising data 210 of the historic customers. The customer classification module 212 may also use other data associated with the historic customers such as whether customer are designated as B2B customers or B2C customers. Given the data about the historic customers, the customer classification model module 212 employs a machine learning technique to correlate a propensity of interactions of the historic customers with the online store, attributes of both purchased and unpurchased items of online shopping carts of the historic customers, and cross-channel information as indicative of interactions of the historic customers to purchase items in their online shopping carts.

In one or more implementations, the model generated by the customer classification model module 212 is a logistic regression model. Although the following discussion describes details of implementing online shopping cart analysis using a logistic regression, it should be appreciated that other modeling techniques that involve machine learning may be used by the online shopping cart analysis module 108. By way of example and not limitation, the customer classification model module 212 may use modeling techniques that involve machine learning such as random forests, survival models, neural networks, and other modeling techniques without departing from the techniques described herein.

In one or more implementations, the customer classification model module 212 computes the probabilities that an abandoner of an online shopping cart is a true customer according to the following:

$$P ( returning to purchase \vert X = x ) = \frac{exp ( {β}_{0} + {β}_{1} {x}_{1} + {β}_{2} {x}_{2} + … + {β}_{k} {x}_{k} )}{1 + exp ( {β}_{0} + {β}_{1} {x}_{1} + {β}_{2} {x}_{2} + … + {β}_{k} {x}_{k} )}$$

Here, the term X represents the different pieces of data that are collected about customers and their shopping carts to build the model, which is the same data collected about a customer to compute their likelihood to return to purchase items in an abandoned shopping cart. Using a logistic regression, the customer classification model module 212 outputs values that are between zero and one. Further, the customer classification model module 212 defines the “true customers” as those customers whose value returned from the logistic regression is above a certain threshold value. The true customer threshold value is represented in the following discussion as the term p_{c}. Abandoners whose value is at or above p_{c}. are considered true customers while abandoners whose value is below p_{c} are considered “non-customers”. The customer classification model module 212 determines this threshold value based on a lift curve (e.g., a lift curve reference). The customer classification model module 212 may, for instance, use the lift curve to determine the threshold value so that it results in an optimum lift in correct predictions of true customers, as opposed to randomly classifying online-store visitors as true customers.

The customer classification model module 212 also represents functionality to further segment the customers that are considered non-customers, e.g., due to their computed probability value being below the true customer threshold p_{c}. In particular, the customer classification model module 212 further segments the non-customers into the prospects and the true abandoners. The portion of customers classified into each of these two advertising segments is based on an advertising budget for each type of advertising campaign directed to prospects and true abandoners.

Consider a scenario in which an advertiser has a total budget C with a sub-budget C_{A} that is allocated for campaigning to the true abandoners and another sub-budget Cₚ that is allocated for campaigning to the prospective customers. Consider also that in this scenario there is no budget allocated for campaigning to the true customers, e.g., since no advertising content is to be communicated to these customers to avoid annoying them. In this scenario, the total budget C is be computed as follows:

C=N_{A}C_{A}+(N−N_{A}−N_{C})Cₚ

In this formula, the term N_{A} represents the total number of customers that are classified as true abandoners and the term N_{c} represents the total number of customers that are classified as true customers using the model. The customer classification model module 212 then computes the portion of customers that are true abandoners among the non-customers (determined using the equation above) according to the following:

$$\begin{matrix}q = \frac{{N}_{A}}{N - {N}_{C}} \\ = \frac{( \frac{C - ( N - {N}_{C} ) {C}_{P}}{{C}_{A} - {C}_{P}} )}{N - {N}_{C}} \\ = \frac{C - ( N - {N}_{C} ) {C}_{P}}{( {C}_{A} - {C}_{P} ) ( N - {N}_{C} )}\end{matrix}$$

Another threshold value p_{A}, which may range from zero to one for classifying true abandoners, is defined as the q^{th} quantile (Quantile Reference) of the non-customers.

In addition, the customer classification model module 212 represents functionality to build the model “offline”, e.g., using data that has already been collected. By way of example, the service provider 110 is configured to track interactions of customers over multiple shopping sessions as well as attributes of items added to their online shopping carts during the multiple shopping sessions. The service provider 110 stores this data as part of the customer accounts 204, e.g., as the online shopping cart data 206, online store browsing data 208, and the cross-channel advertising data 210. To build the model, the customer classification model module 212 simply accesses this stored data. The data may be communicated to the customer classification model module 212 by the service provider 110 over the network 112, for example. Alternately, the online shopping cart analysis module 108 is implemented by the service provider 110 so that communication over the network 112 need not occur.

In any case, the data that is stored and used by the customer classification model module 212 to build a model is considered “historical” because it precedes the building of the model. This contrasts with data that is collected about a subsequent customer and input to an already-built model for the purpose of computing a likelihood that the subsequent customer will return to purchase items from an abandoned cart. Further, the historical data is collected for customers other than the subsequent customer that have abandoned an online shopping cart with unpurchased items during some shopping session, e.g., one or more shopping sessions that precede building the model. The customers for which the likelihood is computed using the model, however, are considered “subsequent” because their likelihood-to-return is computed after the model is built based on the data collected about the other historical customers. At any rate, the process of building the model by the customer classification model module 212 serves to define the above-discussed thresholds as well as parameter estimates for segmenting customers.

In general, the customer scoring module 214 represents functionality to use the model of correlated actions to associate a market segment with a given subsequent customer when the given subsequent customer abandons an online shopping cart. Consider a scenario in which a subsequent customer's interactions are tracked while the customer browses the web pages of the online store, e.g., during a shopping session. During the shopping session, the subsequent customer may add one or more items (e.g., goods or services) that are purchasable from the online store to an online shopping cart. From the shopping cart, the customer may purchase the goods by “checking out” from the store.

In this particular scenario, however, the subsequent customer eventually leaves the store without purchasing at least one item in the online shopping cart. In other words, the subsequent customer abandons the online shopping cart. The subsequent customer may “leave” the online store by navigating to a different web page, closing a web browser used to browse the online store, switching to a different tab of a web browser to perform navigation, closing a dedicated application for shopping at the online store, and so forth. When the subsequent customer is determined to have left the store, it is also determined whether the subsequent customer has left one or more items in the online shopping cart.

In response to these determinations (e.g., the subsequent customer has left the store and unpurchased items remain in the online shopping cart), the customer scoring module 214 computes the probability that the subsequent customer will return to the online store to purchase the items left in the abandoned cart. Based on the calculated probability and the parameters defined in the building of the model, the subsequent customer is associated with a marketing segment, e.g., the subsequent customer is classified as a “true abandoner”, a “prospect”, or a “true customer”.

To classify the subsequent customer in this way, the customer scoring module 214 references the true abandoner threshold p_{A} and true customer threshold p_{c}, which are defined in conjunction with building the model as described above using the historical data of the other historical customers. Further, the customer scoring module 214 collects data about the subsequent customer and the items left in the subsequent customer's abandoned shopping cart. In particular, the customer scoring module 214 collects the same data about the subsequent customer and the items left in the abandoned shopping cart as was collected about the other historic customers to build the model. By way of example, if historic browsing data and attributes of cart items were collected for the other historic customers to build the model, then browsing data and attributes of cart items are also collected for the subsequent customer being classified by the customer scoring module 214.

Using the model built by the customer classification model module 212, the customer scoring module 214 computes the probability p of the subsequent customer to return to the online store to purchase the items left in the online shopping cart. The customer scoring module 214 then associates an advertising segment with the subsequent customer as follows:

p_{c}<p then the subsequent customer is a “true customer”

p_{A}<p<p_{c} then the subsequent customer is a “prospect”

p<p_{A} then the subsequent customer is a “true abandoner”

By segmenting subsequent customers that abandon items in online shopping carts in this way, advertisers may spend advertising money on the “prospects” rather than “true customers” and “true abandoners”. As a result of targeting advertising content to subsequent customers classified as prospects, businesses may be able to convince a greater number of those customers to return to the online store to purchase items left in abandoned shopping carts. By convincing more customers to return to purchase items in abandoned shopping carts, these businesses also therefore generate more revenue, e.g., customers spend more money at the online store. Although communicating targeted advertising content to prospects is described, it should be appreciated that targeted advertising content may also be communicated to customers classified as true abandoners and true customers.

Further, the customer scoring module 214 represents functionality to classify subsequent customers “online”, e.g., in response to a subsequent customer leaving the online store with unpurchased items in an online shopping cart. In other words, the customer scoring module 214 classifies subsequent customers as they leave the online store. With reference to a time when the model is built, the customer scoring module 214 uses the model to classify customers after the model is built. Thus, the model is used to classify customers that abandon shopping carts subsequent to the customers from which the historic data was collected.

Having discussed example details of the techniques for online shopping cart analysis, consider now some example procedures to illustrate additional aspects of the techniques.

### Example Procedures

This section describes example procedures for online shopping cart analysis in one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures are performed by a suitably configured device, such as the example computing device 102 of FIGS. 1 and 2 that makes use of an online shopping cart analysis module 108.

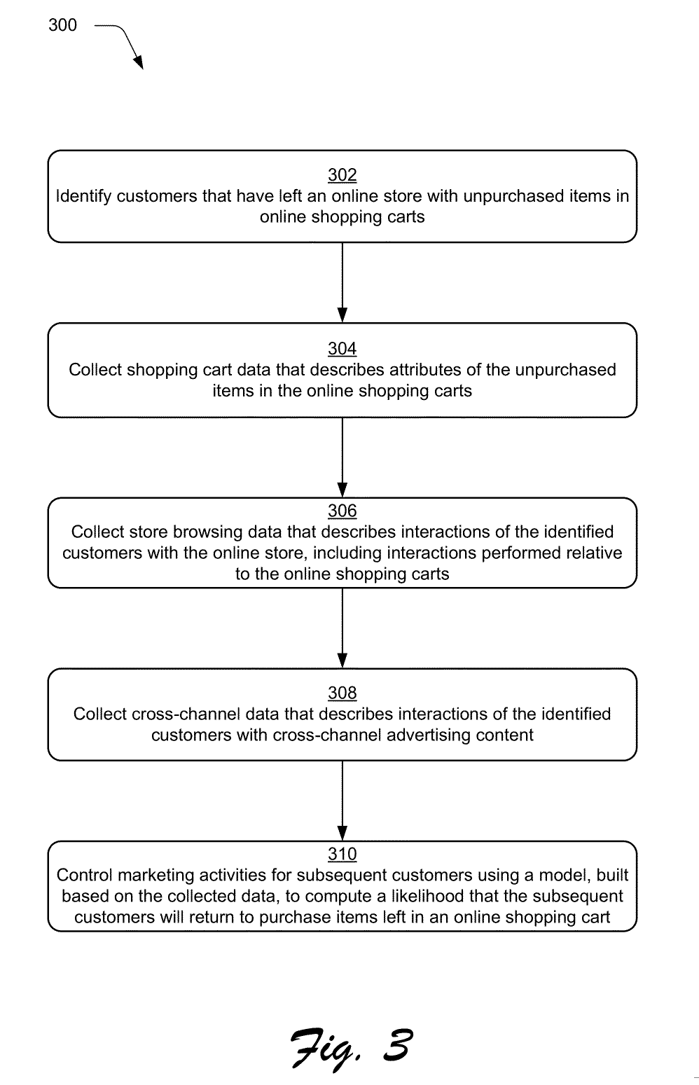

FIG. 3 depicts an example procedure 300 in which data is collected for customers that have left an online store with unpurchased items in an online shopping cart, and in which marketing activities directed at subsequent customers are controlled using a model that is built from the collected data. Initially, customers that have left an online store with unpurchased items in online shopping carts are identified (block 302). For example, the customer classification model module 212 identifies customer that have abandoned an online store provided by the service provider 110. The customer classification model module 212 does so by analyzing data associated with the customer accounts 204. The online store browsing data 208 indicates which of the customer accounts 204 are associated with customers that abandoned an online shopping cart during at least one shopping session. As described above, by “abandon” it is meant that the customer added at least one item to an online shopping cart and left the online store without purchasing the item held in the online shopping cart.

Shopping cart data is collected that describes attributes of the unpurchased items in the online shopping carts (block 304). For example, the customer classification model module 212 collects the online shopping cart data 206 for the customers identified at block 302. The customer classification model module 212 may request this data from the service provider 110. Alternately, the service provider 110 may communicate this information to the computing device 102 without the information being requested by the customer classification model module 212, e.g., as part of a regular “data dump” to generate an up-to-date model for indicating a likelihood that a given customer will return to the online store to purchase items left in an abandoned online shopping cart.

The customer classification model module 212, for instance, collects data describing attributes of the unpurchased items such as an average amount of time unpurchased items are held in an online shopping cart, an average price of the items in an online shopping cart, a total cost of items in an online shopping cart, and so on. In addition, shopping cart data is collected that describes attributes of items that the identified customers purchased from the online shopping carts. By way of example, the customer classification model module 212 collects the online shopping cart data 206 that describes attributes of items purchased from persistent shopping carts, e.g., the shopping carts were abandoned at an earlier shopping session but at least one item was purchased therefrom. The attributes of the items described by the collected data includes a median age of items purchased from an online shopping cart, a number of cart interactions a customer has per shopping session, an average time between a first interaction of a customer with an online shopping cart and purchase of items from the online shopping cart, and so forth.

Store browsing data is collected that describes interactions of the identified customers with the online store (block 306). In one or more implementations, the interactions described by the store browsing data include interactions of the identified customers with the online shopping carts. For example, the customer classification model module 212 collects the online browsing data 208 from the service provider 110 for the customers identified in block 302.

Cross-channel data is collected that describes interactions of the identified customers with cross-channel advertising content (block 308). For example, the customer classification model module 212 collects the cross-channel advertising data 210 from the service provider 110 for the customers identified in block 302.

Marketing activities directed to subsequent customers are controlled using a model that is built based on the collected data (block 310). The model is usable to compute a likelihood that subsequent customers that abandon an online shopping cart will return to purchase the unpurchased items left therein. With regard to controlling marketing activities, the online shopping cart analysis module 108 causes a segment of customers not to receive targeted advertising content. The online shopping cart analysis module 108 also causes a different segment of customers to receive targeted advertising content. To do so, the customer classification model module 212 builds a model that is usable to compute a likelihood that a subsequent customer that abandons an online shopping cart will return to purchase items left in the abandoned shopping cart. The marketing activities are controlled based on the computed likelihood of the subsequent customer to return to purchase the items left in the abandoned shopping cart.

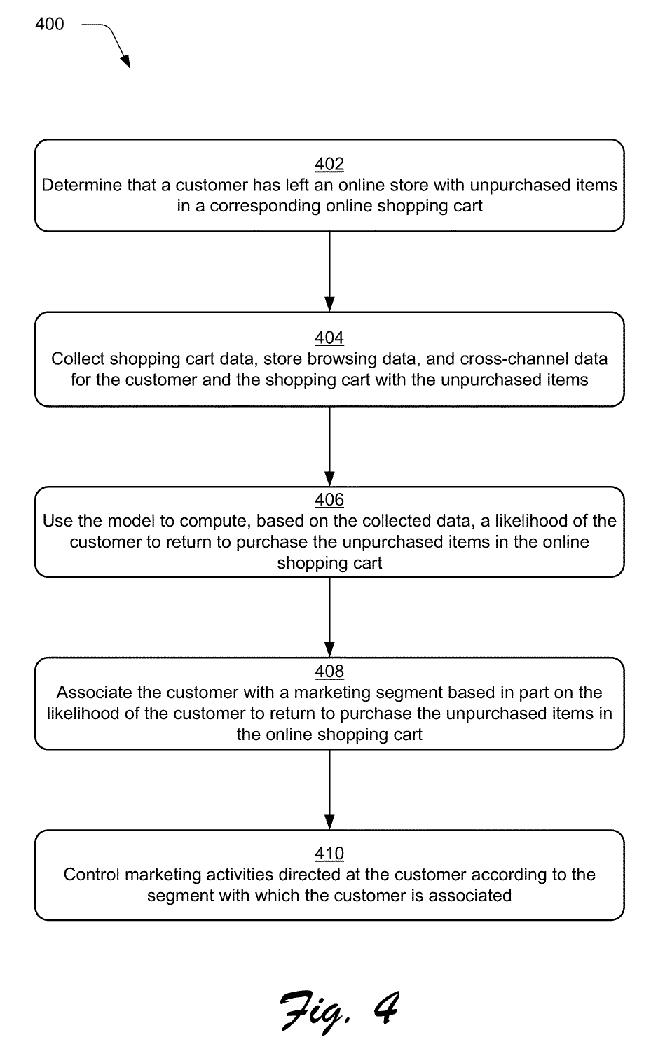

FIG. 4 depicts an example procedure 400 in which a customer that leaves an online store with unpurchased items in an online shopping cart is associated with a marketing segment based on a likelihood of the customer to return and purchase the unpurchased items, and in which the likelihood is computed using the model discussed above. First, it is determined that a customer has left an online store with unpurchased items in a corresponding online shopping cart (block 402). For example, the online shopping cart analysis module 108 is notified that a customer having one of the customer accounts 204 leaves an online store that corresponds to the service provider 110. Customers that browse through the online store have their actions tracked. When the tracked actions indicate that a customer has left the online store, and has left at least one item in an online shopping cart, the online shopping cart analysis module 108 is notified. Once notified that a customer has abandoned a shopping cart, the online shopping cart analysis module 108 initiates the process to classify the customer for marketing activities. In addition or alternately, the online shopping cart analysis module 108 may actually perform the tracking and thus initiate the classification process when an action performed by a customer indicates they have abandoned a shopping cart.

In response to a determination that the customer has left the online store, data is collected for the customer and for the shopping cart with the unpurchased items (block 404). For example, the online shopping cart analysis module 108 collects data from the customer accounts 204 about the abandoning customer and about the items in the shopping cart, e.g., the online shopping cart data 206, the online store browsing data 208, and the cross-channel advertising data 210.

It should be noted that the collected data may describe interactions of the customer with the online store during the shopping session just terminated, as well as interactions of the customer with the online store during previous shopping sessions. Moreover, the data may be collected from sources other than just the service provider 110. By way of example and not limitation, the data is collected from a browser or dedicated application that the customer uses to interact with the online store. In any case, the data collected for the abandoning customer and the items in the abandoned shopping cart describes the same customer interactions and item attributes as the historic data collected to build the model. For instance, if a median age of items purchased from an online cart was collected for identified abandoners to build the model, then a median age of items purchased from an online cart is collected for the abandoning customer.

Based on the collected data, a likelihood is computed using the model that indicates a likelihood that the customer will return to purchase the unpurchased items in the online shopping cart (block 406). For example, the customer scoring module 214 computes a likelihood that the customer, determined to have left the online store with unpurchased items in the online shopping cart at block 402, will return to the online store to purchase at least one of those items. To do so, the customer scoring module 214 uses the data collected about the abandoning customer at block 404 as input to the model. The likelihood of the customer to return to the online store to purchase at least one of the items in the abandoned shopping cart is then returned.

Based in part on the likelihood of the customer to return to purchase the unpurchased items, the customer is associated with a marketing segment (block 408). For example, the customer scoring module 214 associates the customer with marketing segments such as “true abandoner”, “prospect”, and “true customer”. Each of these marketing segments is associated with a range of likelihoods that the customer will return. By way of example, if the likelihood that the customer will return to purchase an item is anywhere in the range of 90-100%, the customer scoring module 214 associates the customer with the “true customer” segment. As discussed above, however, the ranges of likelihoods that correspond to each of the marketing segments are ascertained when the model is built. This is the case because the thresholds for “true abandoner”, “prospect”, and “true customer” depend on the historic data.

Marketing activities directed at the customer are controlled according to the segment with which the customer is associated (block 410). By way of example, an advertiser may determine that no marketing activity is to be taken for true customers. Thus, if the customer is associated with the true customer marketing segment, no marketing activity is taken for the customer. Advertisers may decide to take no marketing activity for true customers because they are likely to return to the online store to purchase items left in an abandoned cart anyway and may be annoyed by advertising content.

In contrast, if the customer is associated with the prospect segment, then advertising content is communicated to the customer to encourage the customer to purchase the items left in the abandoned cart. By way of example, an email or banner advertisement offering free shipping or a discount over a competitor's prices is communicated to the customer. Different marking activities may be performed for a customer that is associated with the true abandoner segment. In other words, each marketing segment is associated with one or more marketing activities. Consequently, a customer's association with a particular marking segment dictates the marketing activities to which the customer is subjected.

Having described example procedures in accordance with one or more implementations, consider now an example system and device that can be utilized to implement the various techniques described herein.

### Example System and Device

FIG. 5 illustrates an example system generally at 500 that includes an example computing device 502 that is representative of one or more computing systems and/or devices that implement the various techniques described herein. This is illustrated through inclusion of the online shopping cart analysis module 108, which operates as described above. The computing device 502 may be, for example, a server of a service provider, a device associated with a client (e.g., a client device), an on-chip system, and/or any other suitable computing device or computing system.

The example computing device 502 includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This includes implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 502, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that is employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules are implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software are achieved at least partially in hardware, e.g., through use of computer-readable storage media and/or hardware elements 510 of the processing system 504. The instructions and/or functions are executable/operable by one or more articles of manufacture (for example, one or more computing devices 502 and/or processing systems 504) to implement techniques, modules, and examples described herein.

The techniques described herein are supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 abstracts resources and functions to connect the computing device 502 with other computing devices. The platform 516 also serves to abstract scaling of resources to provide a corresponding level of scale to encountered demand for the resources 518 that are implemented via the platform 516. Accordingly, in an interconnected device implementation, implementation of functionality described herein is distributed throughout the system 500. For example, the functionality is implemented in part on the computing device 502 as well as via the platform 516 that abstracts the functionality of the cloud 514.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital environment in which users select items such as goods or services for potential purchase via an online store and an online shopping cart is used to maintain the user-selected items, a method of quantifying likelihood of future purchases of the items by one or more computing devices, the method comprising:
identifying customers that have left an online store with unpurchased items in one or more online shopping carts that enable purchase of items from the online store;
collecting data that describes:
interactions of the identified customers with the online store, the interactions including interactions of the identified customers to purchase items from the online shopping carts;
attributes of both the unpurchased items in the online shopping carts and items that have been purchased from the online shopping carts; and
cross-channel information that involves interaction of the identified customers with content that is accessed through one or more sources of content other than the online store;
generating a model from the collected data using a machine learning technique that correlates a propensity of the interactions of the identified customers, the attributes of the unpurchased items in the online shopping carts, the attributes of the items that have been purchased from the online shopping carts, and the cross-channel information as indicative of the interactions of the identified customers to purchase the items from the online shopping carts;
using the model of correlated interactions to compute a likelihood that one or more subsequent customers that leave the online store with one or more unpurchased items in a corresponding said online shopping cart return to purchase the one or more unpurchased items; and
controlling which of a plurality of marketing activities are directed at the one or more subsequent customers based on the likelihood computed using the model.

2. A method as described in claim 1, wherein the collected data further describes:
a number of interactions each of the identified customers have with the online shopping carts per shopping session;
the interactions of the identified customers with the online store during a current shopping session;
the interactions of the identified customers with the online store during any previous shopping sessions;
an average time between a first interaction of the identified customers with the online shopping carts and a conversion interaction of the identified customers to purchase items held in the online shopping carts;
a median age of the items in the online shopping carts that are converted from being held in the online shopping carts to being purchased from the online shopping carts;
a median age of the unpurchased items in the online shopping carts; or
information designating the identified customers as being a business-to-business customer or a business-to-consumer customer.

3. A method as described in claim 1, wherein the machine learning technique that correlates the propensity of the interactions of the identified customers, the attributes of the unpurchased items in the online shopping carts, the attributes of the items that have been purchased from the online shopping carts, and the cross-channel information as indicative of the interactions of the identified customers to purchase the items from the online shopping carts is logistic regression.

4. A method as described in claim 1, wherein controlling which of the plurality of marketing activities are directed at the one or more subsequent customers includes not communicating advertising content to the one or more subsequent customers when the likelihood indicates that the one or more subsequent customers are likely to return to purchase the unpurchased items.

5. A method as described in claim 1, wherein controlling which of the plurality of marketing activities are directed at the one or more subsequent customers includes communicating advertising content to the one or more subsequent customers based on the likelihood of the one or more subsequent customers to return to purchase the unpurchased items.

6. A method as described in claim 1, wherein the interactions described by the collected data include interactions of the identified customers that occurred over multiple shopping sessions at the online store.

7. A method as described in claim 5, wherein the multiple shopping sessions include shopping sessions in which the identified customers purchased the items that have been purchased from the online shopping carts.

8. A method as described in claim 1, wherein the collected data further describes a number of searches performed by the identified customers for the unpurchased items after the identified customers left the online store with the unpurchased items in the online shopping carts.

9. A method as described in claim 1, wherein the cross-channel information describes interactions of the identified customers with advertising content associated with the online store.

10. A method as described in claim 1, further comprising, after the model is built:
determining that the one or more subsequent customers have left the online store with the one or more unpurchased items in the corresponding online shopping cart; and
collecting data associated with the one or more subsequent customers that describes interactions of the one or more subsequent customers with the online store, attributes of the one or more unpurchased items in the corresponding online shopping cart, attributes of one or more items that the one or more subsequent customers have purchased from the online shopping carts, and cross-channel information for the one or more subsequent customers.

11. In a digital environment in which users select items such as goods or services for potential purchase via an online store and an online shopping cart is used to maintain the user-selected items, a method of controlling marketing activities related to sale of the items maintained in the online shopping cart by one or more computing devices, the method comprising:
determining that a customer of an online store has left without purchasing one or more items that the customer added to a corresponding online shopping cart;
collecting data that describes interactions of the customer with the online store, attributes of the one or more items in the corresponding online shopping cart, attributes of items that the customer has purchased from the corresponding online shopping cart, and cross-channel information that involves interaction of the customer with content that is accessed through one or more sources of content other than the online store; and
controlling which of a plurality of marketing activities are directed at the customer by computing, based on the collected data, a likelihood of the customer to return to the online store to purchase the one or more items in the corresponding online shopping cart, the likelihood computed using a model generated based on historic data collected for one or more previous customers that were identified to have left the online store with at least one item remaining in one or more online shopping carts, the model further generated from the historic data using a machine learning technique that correlates a propensity of interactions of the one or more previous customers with the online store, attributes of the at least one remaining item in the one or more online shopping carts, attributes of one or more items that the one or more previous customers have purchased via the one or more online shopping carts, and cross-channel information for the one or more previous customers as indicative of interactions of the one or more previous customers to purchase items from the one or more online shopping carts.

12. A method as described in claim 11, wherein the historic data describes:
a number of interactions the one or more previous customers have with the one or more online shopping carts per shopping session;
the interactions of the one or more previous customers with the online store during a current shopping session;
the interactions of the one or more previous customers with the online store during any previous shopping sessions;
an average time between a first interaction of the one or more previous customers with the one or more online shopping carts and a conversion interaction of the one or more previous customers to purchase items held in the one or more online shopping carts;
a median age of the items in the one or more online shopping carts that are converted from being held in the online shopping carts to being purchased from the one or more online shopping carts; or
information designating the one or more previous customers as being a business-to-business customer or a business-to-consumer customer.

13. A method as described in claim 11, wherein the machine learning technique is logistic regression.

14. A method as described in claim 11, wherein the model enables the collected data of the customer to be used as input and the likelihood to be returned as output.

15. A method as described in claim 11, wherein the historic data describes:
the interactions of one or more previous customers with the online store, including browsing interactions at the online store and the interactions of the one or more previous customers to purchase items from the one or more online shopping carts;
the attributes of the at least one remaining item; and
interactions of the one or more previous customers with advertising content outside of the online store.

16. A method as described in claim 11, further comprising:
associating an advertising segment with the customer based on the computed likelihood; and
controlling which of the plurality of marketing activities are directed at the customer by:
communicating advertising content to the customer when the advertising segment with which the customer is associated is designated to receive the advertising content; or
keeping from communicating advertising content to the customer when the advertising segment with which the customer is associated is designated not to receive the advertising content.

17. A system implemented in a digital environment in which user selected items such as goods or services for potential purchase via an online store and an online shopping cart is used to maintain the user-selected items, the system configured to control marketing activities related to sale of the items maintained in the online shopping cart and comprising:
one or more modules implemented at least partially in hardware, the one or more modules configured to perform operations comprising:
tracking interactions of an online store customer, including interactions over multiple shopping sessions at the online store; and
responsive to a determination that the online store customer has ended a current shopping session at the online store with one or more unpurchased items in an online shopping cart, controlling marketing activities directed to the online store customer based on a likelihood of the online store customer to return to the online store for a future shopping session to purchase the one or more unpurchased items, the likelihood computed based in part on the tracked interactions and attributes of the one or more unpurchased items.

18. A system as described in claim 17, wherein the interactions that are tracked further include interactions of the online store customer to purchase one or more items that were added to the online shopping cart during the multiple shopping sessions.

19. A system as described in claim 18, wherein the likelihood of the online store customer to return to the online store for the future shopping session to purchase the one or more unpurchased items is based in part on attributes of the one or more purchased items.

20. A system as described in claim 17, further wherein controlling the marketing activities directed to the online store customer includes:
associating an advertising segment with the online store customer based on the computed likelihood; and
selecting which of a plurality of marketing activities are directed at the online store customer by:
communicating advertising content to the online store customer when the advertising segment with which the online store customer is associated is designated to receive the advertising content; or
keeping from communicating advertising content to the online store customer when the advertising segment with which the online store customer is associated is designated not to receive the advertising content.
